(19) United States
(12) Patent Application Publication
(10) Pub. No.: US 2026/0169126 A1
(43) Pub. Date: Jun. 18, 2026

(54) KEYPOINT IDENTIFICATION FOR IMPROVED OBJECT DETECTION IN A RADAR SYSTEM

(71) Applicant: Robert Bosch GmbH, Stuttgart (DE)

(72) Inventors: Sascha Braun, Reutlingen (DE); Alexander Bartler, Villingen-Schwenningen (DE); Daniel Kenta Jenet, Stuttgart (DE); Karim Adel Dawood Armanious, Stuttgart (DE); Marcel Schreiber, Neu-Ulm (DE); Marco Reese, Stuttgart (DE); Maurice Quach, Ditzingen (DE); Michael Ulrich, Stuttgart (DE); Patrick Ziegler, Waiblingen (DE)

(21) Appl. No.: 19/411,617

(22) Filed: Dec. 8, 2025

(30) Foreign Application Priority Data
Dec. 13, 2024 (DE) 10 2024 137 582.5

(51) Int. Cl. G01S 7/41; G01S 13/89; G01S 13/931

(52) U.S. Cl. CPC G01S 7/417; G01S 13/89; G01S 13/931

(57) ABSTRACT

A method for detecting objects in a radar system. The method includes: providing radar measurement values as a list of points, wherein each point comprises associated features; creating object hypotheses based on the radar measurement values by means of a trained artificial neural network, comprising the steps of: creating a feature map based on the radar measurement values, creating a probability distribution over the feature map, wherein each probability maximum corresponds to the most probable keypoint of an object, regression for each keypoint, filtering the probability maxima, and outputting an object hypothesis for each keypoint. A radar system for performing such a method is also described.

### CROSS REFERENCE

The present application claims the benefit under 35 U.S.C. § 119 of Germany Patent Application No. DE 10 2024 137 582.5 filed on Dec. 13, 2024, which is expressly incorporated herein by reference in its entirety.

### FIELD

The present invention relates to a method for improved identification in a radar system by identifying and filtering keypoints of a detected object, and to a radar system for performing this method.

### BACKGROUND INFORMATION

Advanced driver assistance systems (ADAS) and autonomous driving (AD) technologies require accurate and reliable detection of the vehicle's surroundings. These systems utilize a large number of sensors, including cameras as well as point-based sensors such as lidar (light detection and ranging) and radar (radio detection and ranging). These sensors provide measurements in the form of point clouds, enabling a detailed representation of the environment.

A lidar sensor represents each point by Cartesian coordinates (x, y, z) and intensity values of the reflected signal. A radar sensor provides polar coordinates, such as distance and azimuth angle, supplemented by features such as signal strength, radar cross-section (RCS) or elevation angle. From these point clouds, algorithms for detecting surroundings, known as perception algorithms, derive relevant object features such as position, orientation, size and class. This information is essential for safe navigation and decision-making in ADAS and AD systems.

Traditional approaches to detecting surroundings combine tracking algorithms, such as Kalman filters, with downstream object type classification. Such tracking algorithms integrate models that describe the representation of objects in sensor data, such as reflection models for radar data or L-shaped models for lidar data.

Deep neural networks allow for a different approach. Models with deep neural networks can directly identify objects and represent them in the form of oriented bounding boxes (OBBs). These OBBs contain estimates for the probability of an object existing, as well as its position, orientation, size, and class. Applying such methods to radar data presents a particular challenge. This is due to the comparatively lower point density and other physical properties of radar measurements, for example compared to lidar measurements.

In practice, object detection is typically performed by means of region proposal networks (RPNs). These networks identify regions in the measurement data that potentially contain objects, and describe them using what are known as anchor boxes. The RPN evaluates each anchor box on the basis of two key criteria: the probability that the box contains an object (objectness score), including an estimate of the object class, and the precise position and size, i.e., the deviation between the anchor box and the actual bounding box.

The evaluation often generates a large number of object hypotheses for the same object, which must be filtered by methods such as non-maximum suppression (NMS) in order to eliminate redundant hypotheses. However, this method has disadvantages, including the use of numerous parameters needed for filtering and the risk of losing relevant objects due to faulty filtering.

### SUMMARY

It is an object of the present invention to provide a method that improves upon the limitations of existing object detection methods and enables more precise and more efficient detection and classification of objects from radar measurement data. Another object of the present invention is to generate a single object hypothesis for an object in a method. A further object of the present invention is to provide a radar system which enables a method according to the present invention.

These objects may be achieved according to the present invention by a method and a radar system, disclosed herein. Advantageous embodiments and developments of the present invention are disclosed herein.

According to a first aspect of the present invention, a method is provided for detecting objects in a radar system. According to an example embodiment of the present invention, the method comprises: providing radar measurement values as a list of points, wherein each point comprises associated features; and creating object hypotheses based on the radar measurement values by means of a trained artificial neural network, comprising the steps of: creating a feature map based on the radar measurement values, creating a probability distribution over the feature map, wherein each probability maximum corresponds to the most probable keypoint of an object, regression for each keypoint, filtering the probability maxima, and outputting an object hypothesis for each keypoint.

The radar measurement values correspond, for example, to a point cloud, which is provided as an unsorted list and entered into the trained artificial neural network. Each point is characterized by its features, such as radar cross-section (RCS) or the radial velocity compensated for the radar's own motion.

The probability distribution indicates how likely it is that a point or region of the feature map corresponds to the actual keypoint of an object. The probability distribution is generated as a heat map over the feature map. In other words, the artificial neural network estimates, in the radar measurement data transformed into a feature map, the probability that a region of the feature map corresponds to the region, or more precisely, the keypoint, of an object that has been detected by the radar system. The regression for each keypoint can also be carried out by creating the probability distribution or generating the heat map. Preferably, only one keypoint per object is predicted.

According to one example embodiment of the method of the present invention, a keypoint is a defined keypoint of an object.

Radar measurement values, which are detected as point clouds, often have a significantly looser distribution of measurement points than, for example, lidar measurement values. Due to the reflections that occur, radar measurement values are usually grouped at keypoints of an object. Defining which keypoint is to be predicted makes it possible to choose points that contain the most information about the detected object. This improves the quality of the generated object hypotheses. In particular, radar measurements can present the problem whereby, at greater distances between the object and the radar system, the extent of the object is limited due to the sensor resolution and cannot be measured due to the reflection angle. By defining the keypoint, it can be chosen in such a way that these disadvantages are reduced or eliminated. This can improve the estimation of the extent of the object.

According to one example embodiment of the method of the present invention, the keypoint is at least one of: an object reference point facing a radar sensor of the radar system, an object edge facing a radar sensor of the radar system, an axis of the object, or a rapidly rotating region of an object.

The facing reference point can, for example, be the object edge facing the radar system. The reference point, the facing edge, an axis or a rapidly rotating region, such as a wheel, allow improved object estimation due to the strong reflections of the radar signals that occur there. The keypoint can also be the center of the OBB of the object. If the keypoint is placed in the center, a smaller offset of the OBB needs to be estimated, meaning that the position is estimated substantially by predicting the keypoint.

According to one example embodiment of the method of the present invention, the probability distribution is created by means of a function of a standard deviation according to the object size and/or a function of a linearly decreasing probability relative to the distance to the keypoint and/or a function of an exponentially decreasing probability starting from the keypoint.

Additional functions for creating the probability distribution, or rather, the heat map, can also be created. These functions must be designed in such a way that the regions of the feature map that are adjacent to the keypoint have lower values in order to filter said values using a maxima search. The creation of the probability distribution is learned during the training phase of the artificial neural network and is carried out in the method during interference. The artificial neural network can be trained in such a way that, during training, additional regions besides the estimated region that matches the actual keypoint are also learned, thus enabling robust detection even if the keypoint is not predicted precisely. For this purpose, the artificial neural network can be trained in such a way that deviations are output during training which are larger than the theoretical deviation from the object to the keypoint.

According to one example embodiment of the method of the present invention, the feature map comprises a two-dimensional grid and a keypoint corresponds to a cell of the grid.

A two-dimensional grid map is a type of feature map commonly used in the architecture of artificial neural networks. The two-dimensional grid map can be multi-layered, with each layer representing, for example, a type of feature. Therefore, starting from the keypoint, the regression can be carried out for multiple cells of the grid in order to ascertain the OBB, for example, by means of the regression parameters.

According to one example embodiment of the method of the present invention, the creation of a feature map comprises the projection of each point onto a grid and the creation of a feature vector for each point.

In this process, the feature vectors extracted or created from the radar measurement values are embedded in a grid. This can be carried out, for example, by a fully connected neural network (FCNN). This enables, for example, processing into a feature map and evaluation by means of a two-dimensional convolutional neural network (CNN). This includes, for example, a backbone consisting of a residual network and a feature pyramid network. These are able to extract features for different grid resolutions.

According to one example embodiment of the method of the present invention, all points arranged in a cell of the grid are grouped into a pillar and a common feature vector is calculated.

This can be achieved, for example, by a pillar feature network. This involves the measurement data being projected onto a two-dimensional grid in the form of the point cloud, with the features of each point embedded, and all points arranged in a cell of the grid being grouped into a pillar (mean pooling).

Since each point is characterized by a vector of features, mean pooling can increase robustness, improve the compactness of the network, and significantly reduce the required computational load, as the number of points per pillar can vary greatly. For this purpose, the feature vectors of all points are grouped in a pillar by calculating the average over all points in said pillar. The feature vector generated by way of mean pooling therefore corresponds to the mean of the features of all points in the corresponding pillar.

According to one example embodiment of the method of the present invention, if a feature vector has a length equal to or less than a cell of the grid, the feature vector is assumed to extend beyond the cell.

A keypoint is based on a probability distribution that extends across a region of the feature map, for example across multiple cells of a grid in at least one direction. This probability distribution is based on the extent of an object predicted by the trained artificial neural network on the basis of the feature vectors. If an object is so small that its extent lies within a cell due to the resolution of the feature map, the resulting feature vector will also not extend beyond this cell, preventing detection as a keypoint. The embodiment allows such a feature vector to be assumed to extend beyond a cell, thus enabling detection as a keypoint.

According to an example embodiment of the present invention, the network architecture used can comprise a CNN, a sparse grid-based network such as Sparse Convolution or Sparse Window Transformers, a point-based network such as PointNet or PointNet++, or network architectures such as graph neural networks, continuous convolutions, or kernel point convolutions. Other network architectures are also possible.

The method can also be used to detect keypoints of defined objects and thus improve the detection of said objects, such as the detection of localization markers like posts or other significant points, the identification of keypoints of road boundaries or markings, or the detection of corner points of defined regions.

The method can be applied in particular to advanced driver assistance systems (ADAS), but also to automated assembly lines, e.g., for detecting components and their orientation for determining grip points; to automated lawnmowers, e.g., for detecting obstacles; to automatic access controls, e.g., for person detection and identification for automatic door opening; to the monitoring of places or buildings, e.g., for detecting, testing and classifying dangerous goods; to traffic monitoring with stationary radar sensors; and to detecting and classifying road users in an assistance system for bicycles or other two-wheeled vehicles.

According to a further aspect, the present invention comprises a radar system comprising at least one radar sensor; and an evaluation unit designed to perform the object detection method of the present invention according to one of the embodiments described above.

The evaluation unit can include the artificial neural network. In particular, the radar sensor is designed to collect a large number of measurement values and provide them to the evaluation unit. The radar system can, for example, be a vehicle-based radar system.

The method and system according to the present invention offer significant advantages over the related art. Because object hypotheses are created only on the basis of keypoints, there is only one object hypothesis per object. This eliminates the need for complex filtering by means of methods like NMS, which consumes a significant amount of the computing capacity required for the method. The filtering of the probability maxima can be achieved by a simple maxima search (peak search) with low computing capacity, whereby the object hypotheses are output only for the filtered regions. Furthermore, a defined keypoint for creating an object hypothesis can allow a position for the keypoint to be selected which improves the detection and regression of the box parameters of the OBB.

The features described can of course be combined in any way possible, provided this is technically feasible.

### BRIEF DESCRIPTION OF THE DRAWINGS

In the following, exemplary embodiments of the present invention are explained in more detail with reference to the figures.

FIG. 1 shows a method according to the present invention in a first example embodiment.

FIG. 2 shows an exemplary network architecture which is used in the method of FIG. 1.

FIGS. 3A-3D show a stylized processing of measurement data into object hypotheses according to the method of FIG. 1.

FIGS. 4A and 4B show details of the output of a region proposal network in comparison with an output of the method of FIG. 1.

FIGS. 5A and 5B show two application situations of a radar system according to the present invention.

### DETAILED DESCRIPTION OF EXAMPLE EMBODIMENTS

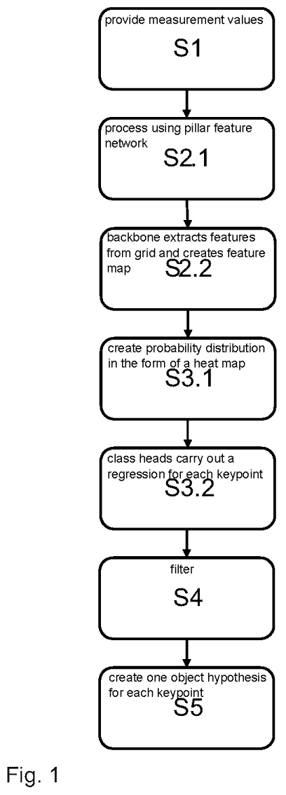

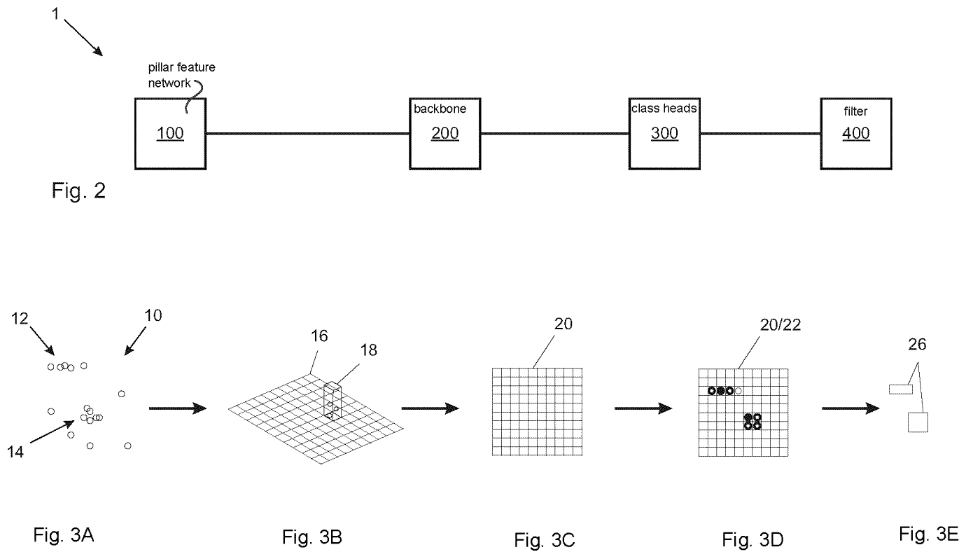

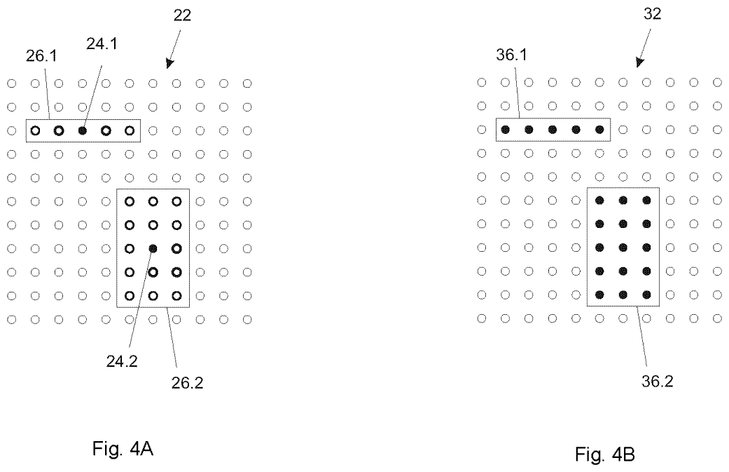

FIG. 1 shows a method according to the present invention in a first embodiment. The method uses, for example, a trained artificial neural network with the network architecture of FIG. 2, and processes data as shown in FIGS. 3A-3D and FIG. 4B. The method is therefore described below on the basis of these figures, but is not limited thereto.

In step S1, measurement values are provided. These are provided, for example, as a point cloud 10 as shown in FIG. 3A, or as a list of unsorted measurement values which, on the basis of their coordinates, produce the point cloud 10 shown. FIG. 3A shows a point cloud 10 with two exemplary regions 12, 14, which have a higher point density. In this example, these regions correspond to two objects from which the received radar signals were reflected.

The measurement values are processed in step S2.1 using a pillar feature network 100 of a trained artificial neural network 1. This projects the point cloud 10 pointwise onto a two-dimensional grid 16, fully embedding the features of each point; see FIG. 3B. In this process, all points arranged in a cell of the grid 16 are grouped into a pillar. One such pillar comprising multiple points is the pillar 18 shown by way of example. For the points contained therein, a common feature vector is calculated by taking the average over all points in this pillar 18. The generated feature vector therefore corresponds to the mean of the features of all points in the pillar 18.

The grid 16 then contains the abstract features of the radar measurement values. In step S2.2, a backbone 200 of the trained artificial neural network 1 extracts features from the grid 16 and creates a feature map 20; see FIG. 3C. In the present embodiment, the backbone 200 comprises a residual network and a feature pyramid network. The created feature map 20 contains predictions about spatial information of the detected objects contained in the measurement values.

In a step S3.1, a probability distribution over the feature map in the form of a heat map 22 is created in the class heads 300; see FIG. 3D. The probability corresponds to a maximum decreasing from the position of a keypoint of an object. In other words, the trained artificial neural network in the class heads 300 predicts the most probable points for a keypoint of each detected object by predicting a probability for a keypoint for each cell of the feature map 20.

Such a heat map 22 is shown in FIG. 4A. This shows a portion of the feature map 20 in FIGS. 3C and 3D. The individual cells of the feature map 20 are represented by anchor boxes, with each anchor box of the heat map 22 corresponding, for example, to a cell of the feature map 20. Each region of the feature map 20 is assigned a probability, which is represented as the line thickness of the anchor box. The point of greatest probability of the keypoint of the object, i.e., a probability maximum, is also referred to as the keypoint below. The heat map 22 shows two exemplary keypoints 24.1 and 24.2. Around this point, the predicted probability for the keypoint decreases as the distance decreases.

In step S3.2, the class heads 300 carry out a regression for each keypoint 24.1, 24.2. A regression can also be carried out for each anchor box of the heat map 22, but is preferably carried out only for the keypoints 24.1, 24.2 determined by the maxima. This determines the parameters of oriented bounding boxes (OBB) 26.1 and 26.2. The keypoints 24.1, 24.2 are, as in the present example, the centers of the boxes 26.1, 26.2, but can also be other defined keypoints of the detected objects such as axes or wheels, for example. The parameters of the boxes 26.1 and 26.2 can be set according to requirements.

FIG. 4B illustrates by way of example the advantages of the method according to the present invention. It shows a heat map 32 created with a region proposal network (RNP), which is also based on the point cloud 10. The probability of existence of a keypoint is identical for each anchor box within the oriented bounding boxes 36.1 and 36.2, which are shown for illustrative purposes only. Thus, a keypoint can neither be identified nor isolated, and an object hypothesis must be output for each anchor box.

In contrast, using the method according to the present invention, the probability maxima or the keypoints 24.1 and 24.2 can be isolated in a step S4 by means of a filter 400, so that in step S5 only one object hypothesis 28 has to be created for each keypoint; see FIG. 3E. This offers the described advantages over conventional methods. The filtering in step S4 is carried out using a maxima filter (peak search), which, on the basis of the smaller probability values of the cells adjacent to the keypoints 24.1, 24.2, or anchor boxes as shown in FIG. 4A, identifies the predicted probability maxima (peaks) and thus the keypoints and can isolate the associated information such as the oriented bounding box.

The output of the trained artificial neural network 1, and thus the aim of the method, are object hypotheses 28. For each object hypothesis 28, an object type classification, the position of the object and the dimensions (length, width, height, orientation) of the OBB 26.1, 26.2 that encloses the object are output. This data can be further processed and used, for example, for object tracking.

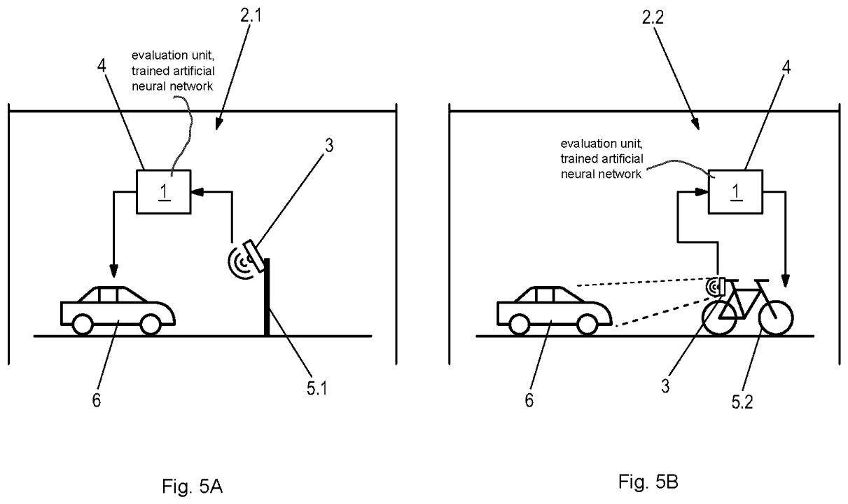

FIG. 5A and FIG. 5B show two possible applications of the method in a radar system 2.1 and 2.2 respectively. Each radar system 2.1 or 2.2 comprises a radar sensor 3 and an evaluation unit 4, wherein the evaluation unit 4 comprises, for example, the trained artificial neural network 1 shown in FIG. 2, and performs the method according to the present invention in FIG. 1. In FIG. 5A, the radar sensor 3 of the radar system 2.1 is a radar sensor of a traffic monitoring unit 5.1, and the evaluation unit 4 can process the radar measurement data of the radar sensor 3 and forward the output object hypotheses to a vehicle 6, which can further process said hypotheses in a driver assistance system. In FIG. 5B, the radar system 2.2 and the radar sensor 3 are part of an assistance system of a two-wheeler 5.2. For example, the radar sensor 3 detects a vehicle 6 behind the two-wheeler 5.2 and the assistance system processes the output object hypotheses.

What is claimed is:

1. A method for detecting objects in a radar system, comprising:
providing radar measurement values as a list of points, wherein each point of the points includes associated features;
creating object hypotheses based on the radar measurement values using a trained artificial neural network, the creating including the following steps:
creating a feature map based on the radar measurement values,
creating a probability distribution over the feature map, wherein each probability maximum of the probability distribution corresponds to a most probable keypoint of an object,
carrying out a regression for each keypoint,
filtering the probability maxima, and
outputting an object hypothesis for each keypoint.

2. The method for detecting objects in a radar system according to claim 1, wherein each keypoint is a defined keypoint of an object.

3. The method for detecting objects in a radar system according to claim 2, wherein each keypoint is at least one of: an object reference point facing a radar sensor of the radar system, or an object edge facing a radar sensor of the radar system, or an axis of the object, or a rapidly rotating region of the object.

4. The method for detecting objects in a radar system to claim 1, wherein the probability distribution is created using a function of a standard deviation according to an object size and/or a function of a linearly decreasing probability relative to a distance to the keypoint and/or a function of an exponentially decreasing probability starting from the keypoint.

5. The method for detecting objects in a radar system according to claim 1, wherein the feature map includes a two-dimensional grid, and each keypoint corresponds to a cell of the grid.

6. The method for detecting objects in a radar system according to claim 5, wherein the creation of a feature map includes a projection of each point onto the grid and the creation of a feature vector for each point of the points.

7. The method for detecting objects in a radar system according to claim 6, wherein all points arranged in a same cell of the grid are grouped into a pillar and a common feature vector is calculated.

8. The method for detecting objects in a radar system according to claim 6, wherein, when a feature vector has a length equal to or less than a cell of the grid, the feature vector is assumed to extend beyond the cell.

9. A radar system, comprising:
at least one radar sensor; and
an evaluation unit configured to perform a object detection method including the following steps:
providing radar measurement values as a list of points, wherein each point of the points includes associated features,
creating object hypotheses based on the radar measurement values using a trained artificial neural network, the creating including the following steps:
creating a feature map based on the radar measurement values,
creating a probability distribution over the feature map, wherein each probability maximum of the probability distribution corresponds to a most probable keypoint of an object,
carrying out a regression for each keypoint,
filtering the probability maxima, and
outputting an object hypothesis for each keypoint.
